(19) United States
(12) Patent Application Publication
(10) Pub. No.: US 2006/0198613 A1
(43) Pub. Date: Sep. 7, 2006

(54) Gymnastic guide system displayed in a computer

(76) Inventor: Jae Ho Lee, Allendale, NJ (US)

Correspondence Address: MCCARTER & ENGLISH, LLP, FOUR GATEWAY CENTER, 100 MULBERRY STREET, NEWARK, NJ, 07102, US

(21) Appl. No.: 11/368,903

(22) Filed: Mar. 6, 2006

(30) Foreign Application Priority Data
Mar. 7, 2005 (KR) 10-2005-0018490

(51) Int. Cl. H04N 5/00

(52) U.S. Cl. 386/125

(57) ABSTRACT

Disclosed herein is a gymnastic guide system displayed in a computer, and more particularly to such a gymnastic guide system in which program is executed to guide a gymnastic exercise every a fixed time interval in a computer so as to prevent musculoskeletal disease, etc., caused by a long-term computer work. The gymnastic guide system comprises: a hard disk for storing at least one video data related to gymnastic exercises therein; timer means for generating a certain signal therefrom every time when a predetermined time lapses; execution means for reading out the video data from the hard disk and executing the readout video data in response to the signal generated from the timer means; and a display section for displaying the execution process of the execution means in a moving picture fashion.

### CROSS-REFERENCE TO RELATED APPLICATION

This application claims the priority of Korean Patent Application No. 10-2005-0018490 filed Mar. 7, 2005, the disclosure of which is incorporated herein by reference in its entirety for all purposes.

### BACKGROUND OF THE INVENTION

1. Field of the Invention

The present invention relates to a gymnastic guide system displayed in a computer, and more particularly to such a gymnastic guide system in which program is executed to guide a gymnastic exercise every a fixed time interval in a computer so as to prevent musculoskeletal disease, etc., caused by a long-term computer work.

2. Background of the Related Art

In general, a computer user does a document, a CAD, a multimedia, a game, a chat, Internet communications, an Internet search, etc., with him or her exposed to a monitor screen of the computer for a long time period. In this case, the computer user moves only his or her wrist and eyes, but not his or her body while sitting in front of the computer for a long time period. Accordingly, there is a high possibility of occurring musculoskeletal diseases such as convulsion, spasticity, pain, paralysis, myoparalysis, ect., in waist, shoulder, neck, wrist, forearm, etc. Specifically, there occurs a vascular disorder such as thrombus caused by cholesterol and vascular occlusion due to the thrombus as western-meals are currently popularized.

To address and solve the above conventional problems, the research is in progress on various human engineering-based chairs, a computer keyboard, a mouse and the like. However, since such human engineering-based articles are merely temporary measures, they still have a limitation of not capable of essentially preventing or healing the aforementioned musculoskeletal diseases.

### SUMMARY OF THE INVENTION

Accordingly, the present invention has been made in view of the aforementioned problems occurring in the prior art, and it is a primary object of the present invention to provide a gymnastic guide system displayed in a computer, which can essentially prevent or heal musculoskeletal diseases such as convulsion, spasticity, pain, paralysis, myoparalysis, ect., occurring in waist, shoulder, neck, wrist, forearm, etc., when a computer user does his or her work for a long time period.

To accomplish the above object, according to one aspect of the present invention, there is provided a gymnastic guide system displayed in a computer, including:

a hard disk for storing at least one video data related to gymnastic exercises therein;

timer means for generating a specific signal therefrom every time when a predetermined time lapses;

execution means for reading out the video data from the hard disk and executing the readout video data in response to the specific signal generated from the timer means; and

a display section for displaying the execution process of the execution means in a moving picture fashion.

The hard disk further may store audio data associated with the video data therein, and the gymnastic guide system further may include a speaker connected to the execution means.

The gymnastic guide system further may include an environmental setting section for setting the predetermined time of the timer, and selecting the at least one video data stored in the hard disk. The predetermined time is preferably set in one hour unit.

To accomplish the above object, according to another aspect of the present invention, there is also provided a gymnastic guide method displayed in a computer, including the steps of:

(a) installing a predetermined program in a computer;

(b) selecting an option to be executed in an environmental setting section installed in the computer;

(c) initializing and operating a timer built in the computer;

(d) allowing the timer built in the computer to determine whether or not a predetermined time set in the environmental setting section lapses; and

(e) if it is determined that the predetermined time has lapsed, executing the program installed in the computer to allow a display section to display gymnastic guide information in a moving picture fashion thereon.

The step (e) further comprises a step of playing back the audio data associated with the moving picture data to output the played audio data to the outside through a speaker.

The gymnastic guide information displayed in a moving picture fashion includes at least one of free standing exercise, yoga, stretching, aerobics, dance, upper body workout, breathing movement.

### BRIEF DESCRIPTION OF THE DRAWINGS

The above and other objects, features and advantages of the present invention will be apparent from the following detailed description of the preferred embodiments of the invention in conjunction with the accompanying drawings, in which:

FIG. 1 is a schematic block diagram illustrating the inner construction of a gymnastic guide system displayed in a computer according to the present invention;

FIG. 2 is a schematic perspective view illustrating a display section 30 for displaying gymnastic guide information thereon, and a speaker 28 according to the present invention;

FIG. 3 is a schematic diagrammatic view illustrating a window screen configuration of an environmental setting section 10 according to the present invention; and

FIG. 4 is a flowchart illustrating a gymnastic guide process displayed in a computer according to the present invention.

### DETAILED DESCRIPTION OF THE PREFERRED EMBODIMENT

Reference will now be made in detail to the preferred embodiment of the present invention with reference to the attached drawings.

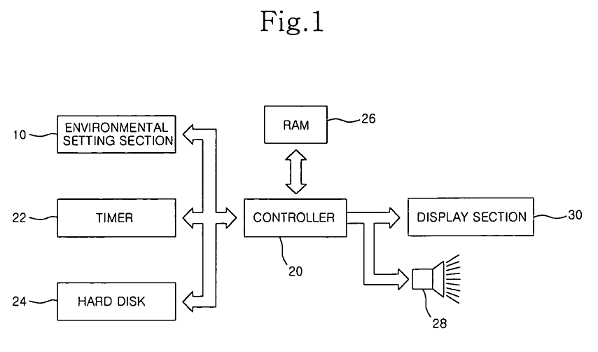

FIG. 1 is a schematic block diagram illustrating the inner construction of a gymnastic guide system displayed in a computer according to the present invention.

Referring to FIG. 1, the gymnastic guide system includes a controller 20, an RAM 26, an environmental setting section 10, a timer 22, a hard disk 24, a display section 30, a speaker 28, etc.

The controller 20 may be a central processor unit (CPU) of a computer. The computer may be a personal computer (PC) or a workstation. This controller 20 serves to execute a series of program commands and controls the respective constituent elements connected to one another.

The RAM 26 is a memory for storing a work memory various data under the control of the controller 20. In this embodiment, the timer 22 as an RAM-resident program may stay in the RAM 26.

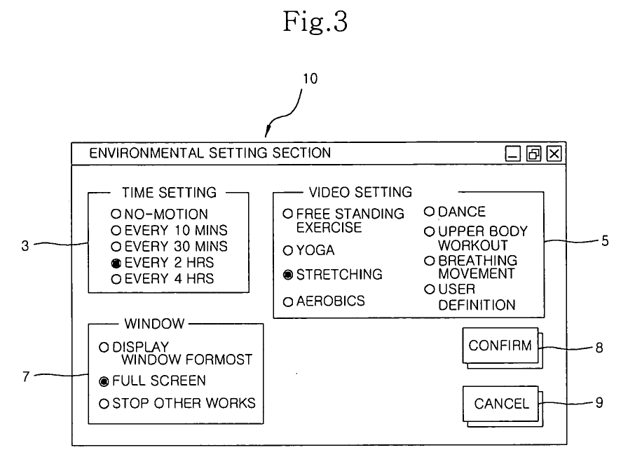

The environmental setting section 10 acts to set various parameters associated with the execution of the gymnastic guide system of the present invention so that the gymnastic guide system can be adjustably executed to conform to the demand of a user. The detailed construction of the environmental setting section 10 will be described later with reference to FIG. 3.

The timer 22 functions to determine whether or not a predetermined time has lapsed in response to a pulse signal of a clock (not shown) built in the computer. Therefore, the timer 22 outputs a certain command signal at a predetermined time interval (for example, one hour, two hour, four hour, etc.).

The hard disk 24 is a memory device built in the computer for storing necessary files or data. Video data or audio data is stored in the hard disk 24 in a specific format (for example, database or file name). Therefore, the hard disk 24 can read and write video data or audio data selected under the control of the controller 20.

The display section 30 is generally a CRT console or a liquid crystal display (LCD) panel, and is connected to the controller 20. The display section 30 serves to display video data to represent it to a user.

The speaker 28 is connected to the controller 20 so as to output the audio data read from the hard disk 24.

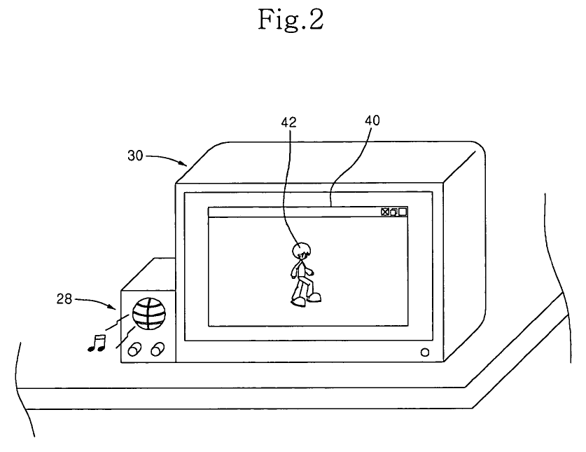

FIG. 2 is a schematic perspective view illustrating a display section 30 for displaying gymnastic guide information thereon, and a speaker 28 according to the present invention.

Referring to FIG. 2, the computer can be a desk top computer or a notebook computer, and the speaker 28 is disposed adjacent to the display section 30. In addition, when program is executed, the display 30 creates a corresponding window 40 thereon to display a character doing a gymnastic exercise on the window screen. Thus, the user stops his or her work and then can practice the gymnastics displayed on the window screen while viewing the motion of the character.

FIG. 3 is a schematic diagrammatic view illustrating a window screen configuration of an environmental setting section 10 according to the present invention.

Referring to FIG. 3, the environmental setting section 10 includes a time setting portion 3, a video setting portion 5, a window setting portion 7, a confirm button 8 and a cancel button 9.

The time setting portion 3 servers to set the time of the timer 22 and the time interval when a corresponding gymnastic program is executed. Therefore, the user can select “No-Motion” to click on it or click on a desired time interval using a mouse (not shown).

The video setting portion 5 acts to designate the kind of gymnastics that the character 42 displayed on the window 40 practices. A user can designate any one of free standing exercise, yoga, stretching, aerobics, dance, upper body workout, breathing movement and user definition in consideration of the healthy condition or individual tastes of a user.

The window setting portion 7 functions to designate the type of the window 40 displayed on the display section 30. When a user selects “position foremost”, the window 40 is created as a foremost one among a plurality of windows created on the display section 30 and then the character 42 starts to move. In this case, it is preferably stop other works and induce the gymnastics.

When the user selects “full screen” in the window setting portion 7, the full screen of the display section 30 but not a window base screen is displayed as a black color, and only the character 42 is displayed on the black full screen.

When the user selects “stop other works” during the multi-task in the computer, the multi-task is stopped. Only one menu may be selected and a plurality of menus may be selected in the window setting portion 7, if necessary.

Besides these menus, the menu of the window setting portion 7 may be configured to set sex (male, female, boy, girl, adolescent), age (teens, twenties, thirties, etc.), garments (casuals, blue jeans, full dresses, etc.), background screen (single-colored background, nature, stage, outskirts, etc), other props, avatas, etc.

When the user clicks on a confirm button 8, the program is executed by using above selected conditions as corresponding parameters. When a cancel button 9 is clicked on, the designated items are ignored so as to end the program.

The operation of the gymnastic guide system having the construction as described above will now be described in detail hereinafter with reference to the accompanying drawings.

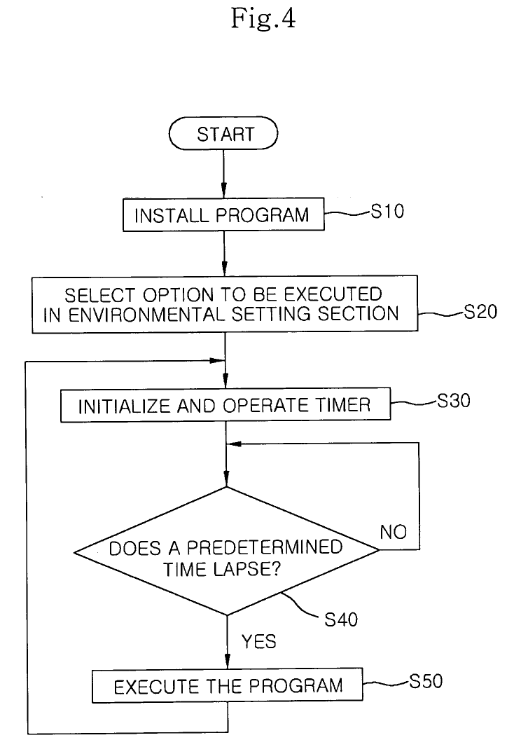

FIG. 4 is a flowchart illustrating a gymnastic guide process displayed in a computer according to the present invention.

Referring to FIG. 4, first, at step S10, a predetermined program is installed in a computer. In this case, an execution program, video data, audio data, an environmental setting section program, and its set data are recorded in the computer hard disk 24, and the timer 22 is registered as a RAM-resident program. An icon may be created on the background screen, if necessary.

Next, at step S20, a user selects an option to be executed in the environmental setting section 10 installed in the computer. That is, the user selects the time interval, the kind of video data, etc., in the environmental setting section 10 shown in FIG. 3 and then clicks on the confirm button 8 to terminate the program.

At step S30, the timer 20 is initialized and operated.

The program proceeds to a subsequent step S40 in which the timer 22 built in the computer determines whether or not a predetermined time lapses. To this end, the timer 22 can be operated as a RAM-resident program.

If it is determined at step S40 that the predetermined time has lapsed, the program proceeds to step S50 where the controller 20 executes the program installed in the computer to allow the display section 30 to display gymnastic guide information thereon. At this time, the audio data associated with the video data is played back to be output to the outside through a speaker 28.

Accordingly, the computer user stops his or her work and practice the gymnastics displayed on the window screen while viewing the motion of the character on the display section 30. as a result, the aforementioned musculoskeletal disease of the user can be prevented and healed.

It will be apparent to those having ordinary skill in the art that although being not shown in this embodiment, general components for operating the computer (for example, graphic cards, sound cards, keyboards, mice, etc.) will be easily configured.

Moreover, only the timer 22 is installed as a RAM-resident program in this embodiment. Other data is stored in a server (not shown) located beyond a network so that one server (now shown) can control a plurality of client computers to execute the above-mentioned operations.

Furthermore, while the present invention has illustrated and described a computer as a main object, it can also be applied to electronic appliances such as TV sets, radios, portable hand-held devices (for example, cellular phones, PDAs, notebook computer, etc.).

As apparent from the foregoing, according to the present invention, it is possible to prevent or heal musculoskeletal diseases such as convulsion, spasticity, pain, paralysis, myoparalysis, ect., in waist, shoulder, neck, wrist, forearm, etc., which can be caused by a long-term computer work.

In addition, since a user is informed of the time lapse every a fixed time interval, he or she can efficiently manage the time.

While the present invention has been described with reference to the particular illustrative embodiments, it is not to be restricted by the embodiments but only by the appended claims. It is to be appreciated that those skilled in the art can change or modify the embodiments without departing from the scope and spirit of the present invention.

What is claimed is:

1. A gymnastic guide system displayed in a computer, comprising:
a hard disk for storing at least one video data related to gymnastic exercises therein;
timer means for generating a certain signal therefrom every time when a predetermined time lapses;
execution means for reading out the video data from the hard disk and executing the readout video data in response to the signal generated from the timer means; and
a display section for displaying the execution process of the execution means in a moving picture fashion.

2. The gymnastic guide system as set forth in claim 1, wherein the hard disk further stores audio data associated with the video data therein, and the gymnastic guide system further includes a speaker connected to the execution means.

3. The gymnastic guide system set forth in claim 1, further comprising an environmental setting section for setting the predetermined time of the timer 22 in such a fashion that the predetermined time is set in one hour unit, and selecting the at least one video data stored in the hard disk.

4. A gymnastic guide method displayed in a computer, comprising the steps of:
(a) installing a predetermined program in a computer;
(b) selecting an option to be executed in an environmental setting section installed in the computer;
(c) initializing and operating a timer built in the computer;
(d) allowing the timer built in the computer to determine whether or not a predetermined time set in the environmental setting section lapses; and
(e) if it is determined that the predetermined time has lapsed, executing the program installed in the computer to allow a display section to display gymnastic guide information in a moving picture fashion thereon.

5. The gymnastic guide method as set forth in claim 4, wherein the step (e) further comprises a step of playing back the audio data associated with the moving picture data to output the played audio data to the outside through a speaker.

6. The gymnastic guide method as set forth in claim 5, wherein the gymnastic guide information in a moving picture fashion comprises at least one of free standing exercise, yoga, stretching, aerobics, dance, upper body workout, breathing movement.

7. The gymnastic guide method as set forth in claim 4, wherein the gymnastic guide information in a moving picture fashion comprises at least one of free standing exercise, yoga, stretching, aerobics, dance, upper body workout, breathing movement.
